(19) United States
(12) Patent Application Publication
(10) Pub. No.: US 2013/0227815 A1
(43) Pub. Date: Sep. 5, 2013

(54) UV Laser Exposure Of Housings And Components Of Door Drives And Door Closers

(71) Applicant: Tim Wulbrandt, Schwelm (DE)

(72) Inventor: Tim Wulbrandt, Schwelm (DE)

(21) Appl. No.: 13/883,722

(22) PCT Filed: Oct. 25, 2011
(86) PCT No.: PCT/EP11/05356

§ 371 Date: May 6, 2013

(30) Foreign Application Priority Data
Nov. 5, 2010 (DE) 10 2010 060 385.6

(51) Int. Cl. E05F 1/00

(52) U.S. Cl. CPC E05F 1/00
USPC 16/71

(57) ABSTRACT

A door operator or a door closer having at least one housing and at least one piston supported to be movable in a reception of the housing. The surfaces of the reception and/or of the at least one piston have been treated by exposure to electromagnetic radiation.

### CROSS REFERENCE TO RELATED APPLICATIONS

This is a U.S. national stage of application No. PCT/EP2011/005356 , filed on 25 Oct. 2011. Priority is claimed on German, Application No.: 10 2010 060 385.6, filed 5 Nov. 2010, the content of which is incorporated here by reference.

### BACKGROUND OF THE INVENTION

1. Field of the Invention

The present invention relates to a door operator or to a door closer, wherein the door operator or the door closer includes at least one housing, a reception, and at least one piston, which is supported to be movable in said reception.

2. Description of Prior Art

A door operator is a device for automatically opening and closing a door. The door may be for example a swing leaf door or a sliding door. A door closer, however, is only utilized for automatically closing a door. In this case, the door operator or the door closer effects in particular the movement of a door leaf into a casing or in relation to a casing. It is known to execute a door operator or a door closer such that a cylindrically shaped reception is located in a housing of the door operator or of the door closer. A piston is supported to be movable in said reception. In particular in a door closer, the movement of the piston has the effect of tensioning a spring or of charging a corresponding energy-accumulating unit upon opening the door. If the door in the opened condition is released, the energy stored in the spring or in the energy-accumulating unit is utilized to close the door. Furthermore, it is known to control and to adjust the closing speed of door closers, additionally likewise the opening speed in a door operator, by suitable methods, for example fluid displacement throttled by valves.

The preferably cylindrically-shaped reception in the housing of the door operator or of the door closer positively surrounds the piston, the circumferential surface of the preferably likewise cylindrically-shaped piston is in contact with the internal circumferential surface of the reception of the housing. Upon actuating the door operator or the door closer, i.e. during an opening process and/or a closing process of the door, and thereby upon moving the piston inside the reception of the housing, the surfaces of the internal circumferential surface of the reception of the housing and the circumferential surface of the piston slide along each other. The friction produced thereby may generate noises that might be considered as disturbing. Furthermore, abrasion may be produced, which might negatively affect the functioning of the door operator or of the door closer.

### SUMMARY OF THE INVENTION

It is an object of the invention to provide a door operator or a door closer of the type described in the introduction, the structural components thereof, in particular the reception in the housing and the piston being treated in a way that the high wear resistance of the door operator or of the door closer is increased and in that the abrasion of the door operator or of the door closer during actuation is reduced.

The problem is solved by a door operator or a door closer of the species mentioned in the introduction, wherein the surface of the reception of at least one housing of the door operator or of the door closer and/or the surface of at least one piston is/are treated by exposure to electro-magnetic radiation, in particular in the ultraviolet range. This treatment modifies the surfaces of the reception and/or of the at least one piston such that the high wear resistance is increased and thus the abrasion is reduced. For example irregularities of the surface of the reception and/or of the at least one piston are smoothed out. Several pistons may be provided for example in a cam door closer.

In a preferred embodiment of the door operator or of the door closer, the surfaces of the reception and/or of the at least one piston have been exposed to electromagnetic radiation of a pulsed excimer laser. Excimer lasers produce electromagnetic radiation in the ultraviolet wave range. Molecules, in particular gaseous molecules are utilized as the laser-active medium. In this case, gases such as hydrogen, argon, or xenon, for example, or a combination of noble gas halogenides, such as argon fluoride or xenon bromide. Excimer lasers are able to reach repetition rates of several kilohertz with pulse energies of up to over 1000 milli-joules. Thus making the specific treatment of metal surfaces of the reception and/or of the at least one piston possible.

According to one advantageous embodiment of the invention, the surfaces of the reception and/or of the at least one piston of the at least one housing of the door operator or of the door closer are treated with electromagnetic radiation having such an energy density in the electromagnetic radiation, that the respective surface will have a modified material structure in a micrometer range, in particular up to a depth reaching from 0.5 micrometer to 2.5 micrometer, when compared to the rest of the material of the at least one housing and/or of the at least one piston. In this case, modified material structure has a higher strength and/or a smoother surface finish than the areas of the door operator or of the door closer which have not been treated with light. By applying a high energy density into the metal surfaces of the reception and/or of the at least one piston, the surfaces are fused in a micro range. Grooves and channels, which are produced when manufacturing the reception and/or the at least one piston, are thus smoothed out when the surface subsequently re-hardens. Furthermore, the crystal structure in the metal is regenerated upon hardening, whereby a higher strength of the surface may be achieved.

In a preferred embodiment of the inventive door operator or of the inventive door closer, it is provided that the surface of the reception and/or the surface of at least one piston are treated with such an energy density of the electromagnetic radiation that the surfaces, on account of plasma formation during the treatment in the micrometer range, in particular up to a depth reaching from 0.5 micrometer to 2.5 micrometer, have a higher nitrogen content than the areas of the door operator or of the door closer which are not treated with light. When treating the surfaces of the reception and/or of the at least one piston by exposure with such an energy density, among other things, nitrogen from the ambient air has been ionized and has formed parts of the plasma. Upon cooling of the plasma and thus the accompanying recombination, nitrogen atoms have been introduced into the crystal lattice of the metal, of which the at least one housing and the at least one piston consist. The treated surfaces thus have a higher nitrogen content than the non-light treated areas of the door operator or of the door closer. A higher nitrogen content results in a higher strength of the surfaces of the reception and/or of the at least one piston, whereby wear and abrasion during operation of the inventive door operator or of the inventive door closer are lowered.

Furthermore, the surfaces of the reception and/or of the surface of at least one piston of the inventive door operator or of the inventive door closer may be treated with such an energy density of the electromagnetic radiation that the surfaces, on account of plasma formation during the treatment in the micrometer range, in particular up to a depth reaching from 0.5 micrometer to 2.5 micrometer, may have a lower graphite content than the areas of the door operator or of the door closer which are not treated with light. Structural components of a door operator or of a door closer, in particular the at least one housing and the at least one piston, are preferably manufactured from casting materials, which are produced in particular in a grey cast iron casting method. In this case, carbon in the shape of graphite is added to the iron. Thereby, the cast iron becomes very hard and is therefore very well suited as a material for door operators or for door closers. Graphite is present in the material as graphite particles. Said particles are considerably softer than the surrounding iron. Upon actuating the door operator or the door closer and the thereto related friction between the reception and/or the at least one piston, abrasion is generated, which consists mostly of graphite. By the treatment with electromagnetic radiation at a high energy density, the graphite particles exposed at the surfaces of the reception and/or of the at least one piston are heated and evaporate. Therefore, after the treatment, the graphite particle content in the light-treated areas of the door operator or of the door closer is lower than before the treatment. Thus, during operation of the door operator or of the door closer, abrasion, in particular graphite containing abrasion can be avoided.

Further advantages, features and details of the invention will result from the following description, in which exemplary embodiments of the invention are described in detail, reference being made to the drawings.

### BRIEF DESCRIPTION OF THE DRAWINGS

The annexed Figures and the description of the Figures are intended for a better understanding of the inventive door operator or of the inventive door closer. Items or parts of items, which are essentially the same or are similar, are identified by the same reference numerals. The Figures are just diagrammatic illustrations of possible embodiments of the invention, in which

FIG. 1: is a perspective view of an inventive door closer;

FIG. 2: is a perspective sectional view of a housing of the inventive door closer according to FIG. 1;

FIG. 3: is a perspective view of a piston of the inventive door closer according to FIG. 1.

### DETAILED DESCRIPTION OF THE PREFERRED EMBODIMENTS

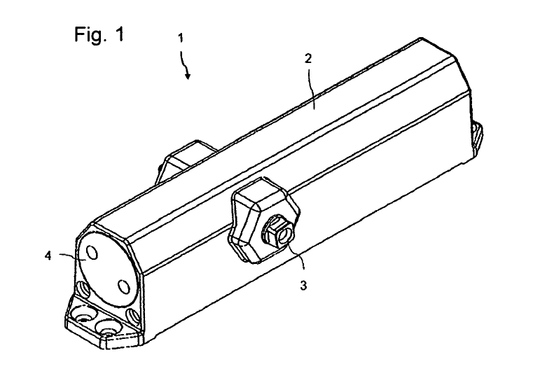

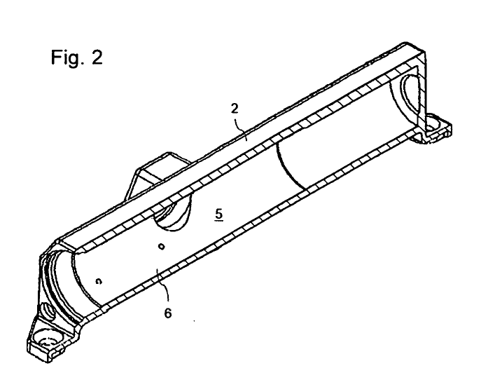

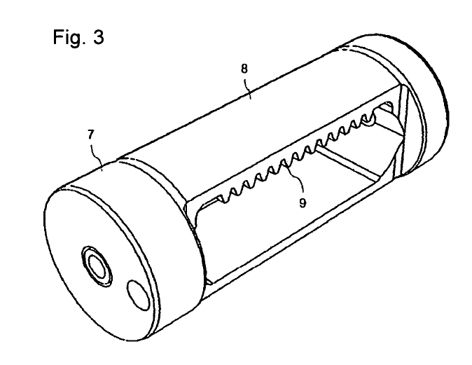

A diagrammatic perspective view of an embodiment of an inventive door closer 1 is shown in FIG. 1. In this case, the mechanical components of the door closer 1 are surrounded by a housing 2. The inside of the housing 2 is accessible through a screwable terminal plate 4. Inside the door closer 1, the mechanical components are actuated by a shaft 3. A piston 7 (FIG. 3) is retained in a movable manner in a reception 5 (FIG. 2) of the housing 2 and is driven via the shaft 3. On account of the inventive treatment of surfaces 6, 8 of the reception 5 and the piston 7, the friction between these structural components of the door closer 1 is reduced. The high wear resistance and the life span of the door closer 1 can be thus increased.

FIG. 2 is a diagrammatic perspective sectional view of the housing 2 of the inventive door closer 1 of FIG. 1. Other structural components are not illustrated. The internal circumferential surface 6 of the reception 5 is clearly visible. The inventive treatment of the surface 6 allows for reducing the friction when operating the door closer 1.

FIG. 3 is a diagrammatic perspective view of the piston 7 of the inventive door closer 1. The toothed rack 9 meshes with a correspondingly configured part of the shaft 3 FIG. 1) and effects a movement of the piston 7 in the reception 5 of the housing 2. In this case, the circumferential surface 8 of the piston 7 bears against the internal circumferential surface 6 of the reception 5 of the housing 2. On account of the inventive treatment of the surfaces 6, 8 with intensive laser light, for example in the ultraviolet range, the surfaces are hardened, smoothed out, and graphite particles have been eliminated. Therefore, a door closer 1, and likewise an analogously configured door operator, with such treated structural components has less wear, lower noise development, and a longer life span.

The elements illustrated in FIGS. 1 to 3 may illustrate a door operator as well. The described advantages are the same as those of the described door closer.

1.-5. (canceled)

6. A door operator or a door closer comprising:
at least one housing having a reception; and
at least one piston arranged to be movable in the reception of the at least one housing,
wherein at least one of a surface of the reception and a surface of the at least one piston is treated with electromagnetic radiation,
wherein the at least one of the surface of the reception and of the surface of the at least one piston has a modified material structure compared to an untreated surface of the at least one housing and of the at least one piston that have not been treated with the electromagnetic radiation, and
wherein the modified material structure has at least one of a higher strength and a smoother surface finish than the untreated surface of the door operator or of the door closer that has not been treated with the electromagnetic radiation.

7. The door operator or the door closer according to claim 6, wherein the electromagnetic radiation is light of a pulsed excimer laser.

8. The door operator or the door closer according to claim 6, wherein an energy density of the electromagnetic radiation produces plasma development such that the at least one of the surface of the reception and of the surface of the at least one piston has a higher nitrogen content than the untreated surface of the door operator or of the door closer that has not been treated with the electromagnetic radiation.

9. The door operator or the door closer according to claim 6, wherein an energy density of the electromagnetic radiation produces plasma development such that the at least one of the surface of the reception and of the surface of the at least one piston has a lower graphite particle content than the untreated surface of the door operator or of the door closer that has not been treated with the electromagnetic radiation.

10. The door operator or the door closer according to claim 6, wherein the modified material structure has a depth reaching from 0.5 μm to 2.5 μm.

11. The door operator or the door closer according to claim 8, wherein a depth of the higher nitrogen content is from about 0.5 μm to about 2.5 μm.

12. The door operator or the door closer according to claim 9, wherein a depth of the lower graphite particle content is from about 0.5 μm to about 2.5 μm.

13. The door operator or the door closer according to claim 7, wherein the at least one of the surface of the reception and of the surface of the at least one piston has a higher nitrogen content than the untreated surface of the door operator or of the door closer which has not been treated with the electromagnetic radiation.

14. The door operator or the door closer according to one of the claim 13, wherein the at least one of the surface of the reception and of the surface of the at least one piston has a lower graphite particle content than the untreated surface of the door operator or of the door closer which has not been treated with the electromagnetic radiation.

15. The door operator or the door closer according to claim 14, wherein the modified material structure has a depth reaching from 0.5 μm to 2.5 μm.

16. The door operator or the door closer according to claim 15, wherein an energy density of the electromagnetic radiation produces plasma development to form the modified material structure.
